(19) United States
(12) Patent Application Publication
(10) Pub. No.: US 2006/0196077 A1
(43) Pub. Date: Sep. 7, 2006

(54) Clothes drying machine and method for removing foreign substances therefrom

(75) Inventor: Han Kyu Choi, Suwon-Si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/271,878

(22) Filed: Nov. 14, 2005

(30) Foreign Application Priority Data
Mar. 3, 2005 (KR) 2005-18322

(51) Int. Cl. F26B 11/02; F26B 19/00

(52) U.S. Cl. 34/602; 34/667

(57) ABSTRACT

A clothes drying machine includes a blade member located in a hot air entrance space formed between a hot air entrance duct and an air entrance portion of a rear plate of a drying tub. The blade member includes a fixed portion fixed to the flange, and a blade portion vertically bent from the fixed portion for generating an air current. The blade member is installed outside the rear plate of the drying tub, and is rotated together with the rotation of the drying tub to generate a vertical air current, thereby dispersing foreign substances present in the lower portion of the hot air entrance space.

### CROSS-REFERENCE TO RELATED APPLICATION

This application claims the benefit of Korean Patent Application No. 2005-18322, filed Mar. 4, 2005, in the Korean Intellectual Property Office, the disclosure of which is incorporated herein by reference.

### BACKGROUND OF THE INVENTION

1. Field of the Invention

The present invention relates to a clothes drying machine and a method for removing foreign substances therefrom, and more particularly, to a clothes drying machine for preventing foreign substances, such as lint, from accumulating therein, and a method for removing foreign substances therefrom.

2. Description of the Related Art

Generally, clothes drying machines are apparatuses for drying wet clothes placed in a drying tub by forcibly blowing hot air to the inside of the drying tub, and employ a forcible circulation method, in which clothes are dried by forcibly circulating hot air heated by a heater and a fan to the inside of the drying tub, or a forcible air exhaustion method, in which air passed through the drying tub is forcibly exhausted to the outside. The clothes drying machines are mainly drum-type clothes drying machines, which rotate a drum containing a large quantity of wet clothes to dry the clothes.

FIG. 1 is a view schematically illustrating the structure of a drying tub of a conventional clothes drying machine. As shown in FIG. 1, the drying tub 1 of the conventional forcible air exhaustion-type clothes drying machine has a drum structure, and includes a front plate 2 provided with an opening 2a, through which clothes are inserted into the drying tub 1, a rear plate 3 provided with a support shaft 3a installed thereon, and a side plate 4 connecting the front plate 2 and the rear plate 3. An air entrance portion 3b is formed on the rear plate 3 so that air heated by a heater 6 installed on the upper portion of the inner surface of a rear panel 5 of a housing passes through a hot air guide duct 7 and is then introduced into the drying tub 1, and a plurality of air inlets 3c are formed through the air entrance portion 3b.

The support shaft 3a is protruded outwardly from the central portion of the air entrance portion 3b of the rear plate 3, and is inserted into an insertion hole 5a formed through the inner surface of the rear panel 5 of the housing, thereby rotatably supporting the drying tub 1.

Accordingly, when the clothes drying machine is operated, the drying tub 1 is rotated at a designated speed and air heated by the heater 6 passes through the hot air guide duct 7 and is introduced into the drying tub 1 through the air inlets 3c, thereby drying wet clothes in the drying tub 1. Here, in order to supply drying force for the rotation of the drying tub 1 and the flow of the air, a motor 8 is installed below the drying tub 1.

In the above clothes drying machine, when the hot air guide duct 7 and the air entrance portion 3b of the drying tub 1 are communicated with each other, a designated space is formed between the hot air guide duct 7 and the air entrance portion 3b of the drying tub 1. That is, a hot air entrance space 9 is formed between the hot air guide duct 7 and the air entrance portion 3b.

Air generally contains various types of dust. When air is introduced into the air inlets 3c of the drying tub 1, the dimensions of an air channel are decreased and the dust accumulates in the hot air entrance space 9. Further, foreign substances, such as lint generated when the clothes are dried in the drying tub 1, are exposed to the hot air entrance space 9 through the air inlets 3c, thus accumulating in the lower portion of the hot air entrance space 9. In the case that the foreign substances accumulate in the hot air entrance space 9 for a long period of time as described above, the overall efficiency of the clothes drying machine is lowered and the dust passed through the heater 6 could start a fire due to the accumulating foreign substances.

### SUMMARY OF THE INVENTION

Illustrative, non-limiting embodiments of the present invention overcome the above disadvantages, and other disadvantages not described above.

An apparatus and method consistent with the present invention provides a clothes drying machine for preventing foreign substances, such as lint, from accumulating in a hot air entrance space formed outside a rear plate of a drying tub, and for removing foreign substances therefrom.

The foregoing and/or other aspects of the present invention are achieved by providing a clothes drying machine with: a drying tub rotatably installed in a housing; a hot air entrance duct communicated with a rear plate of the drying tub for introducing hot air to the inside of the drying tub; and a blade member fixed to the rear plate of the drying tub for preventing foreign substances, such as lint, from accumulating in an hot air entrance space formed between the rear plate of the drying tub and a hot air exit portion of the hot air entrance duct.

According to an aspect of the invention, a flange provided with an integrally formed support shaft may be connected to the rear plate of the drying tub so that the drying tub is rotatably supported by a rear panel of the housing, and the blade member may be fixed to the flange.

Further, preferably, the blade member may include a fixed portion fixed to the flange; and a blade portion vertically bent from the fixed portion and rotated for generating a vertical air current to disperse the foreign substances.

Moreover, preferably, the support shaft may be protruded from the central portion of the flange, and at least one support frame may be protruded from the edge of the flange so that the fixed portion of the blade member is connected to the upper portion of the support frame.

Preferably, the outer part of the blade portion may have an expanded area so that the blade portion efficiently generates an ascending air current to eliminate foreign substances.

Further, an uneven portion for reinforcing the blade portion so that the blade portion is not deformed by air resistance generated when the blade portion is rotated may be formed on the blade portion.

Moreover, preferably, a filter for collecting foreign substances together with air dispersed by the blade member and heated into the drying tub may be installed on a front panel of the drying tub.

In accordance with another aspect, the present invention provides a method for removing foreign substances from a clothes drying machine comprising: dispersing foreign substances present in a space formed between an air entrance portion of a rear plate of a drying tub and a housing by an air current generated by a blade member fixed to the rear plate of the drying tub rotatably installed in the housing and rotating together with the rotation of the drying tub; introducing the dispersed foreign substances together with air introducing from a hot air entrance duct communicated with the rear plate of the drying tub into the drying tub; and collecting the foreign substances introduced into the drying tub through a filter installed in a door installed on a front panel of the housing.

### BRIEF DESCRIPTION OF THE DRAWINGS

These and/or other aspects and advantages of the invention will become apparent and more readily appreciated from the following description of the embodiments, taken in conjunction with the accompanying drawings in which:

FIG. 1 is a view schematically illustrating the structure of a drying tub of a conventional clothes drying machine;

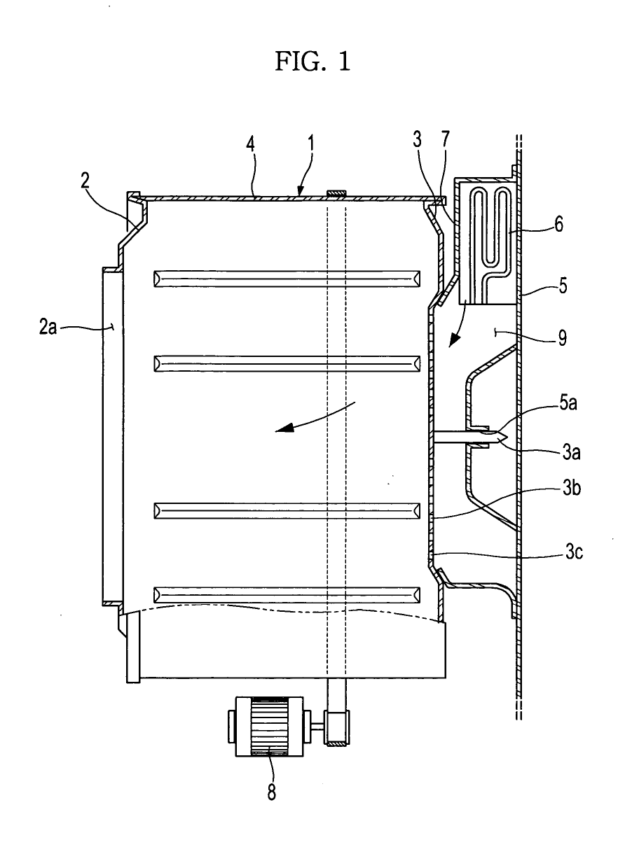

FIG. 2 is a longitudinal sectional view of a clothes drying machine in accordance with the present invention;

FIG. 3 is a perspective view illustrating a rear panel of a housing and a rear plate of a drying tub of the clothes drying machine of the present invention; and

FIG. 4 is an exploded perspective view illustrating the connection among the rear plate of the drying tub, a flange, and a blade member of the clothes drying machine of the present invention.

### DETAILED DESCRIPTION OF THE PREFERRED EMBODIMENTS

Reference will now be made in detail to exemplary embodiments of the present invention, an example of which is illustrated in the accompanying drawings, wherein like reference numerals refer to like elements throughout. The exemplary embodiments are described below to explain the present invention by referring to the figures.

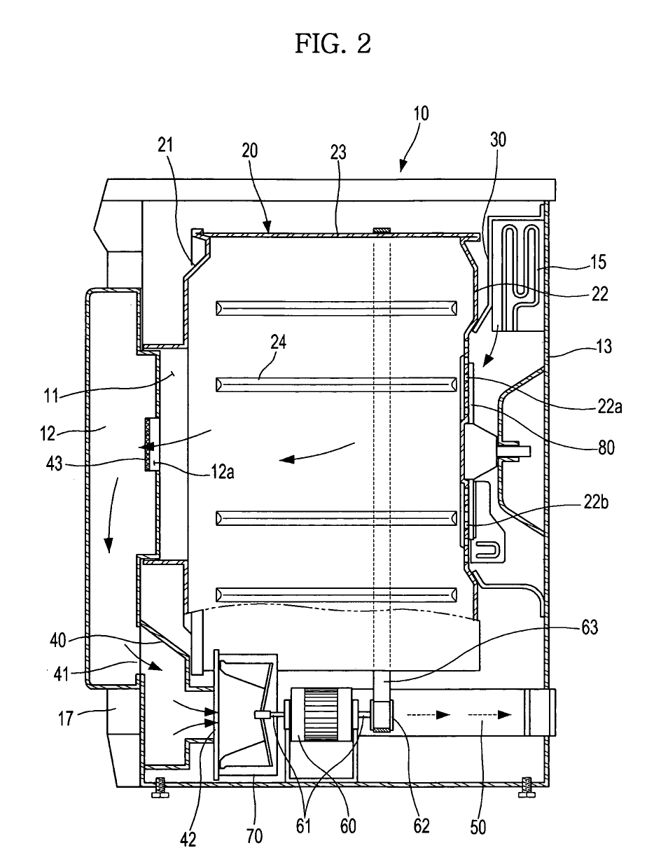

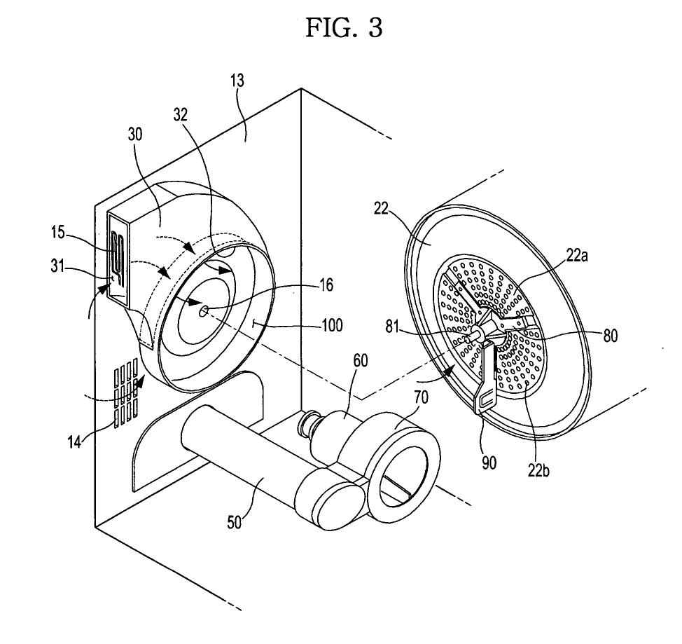

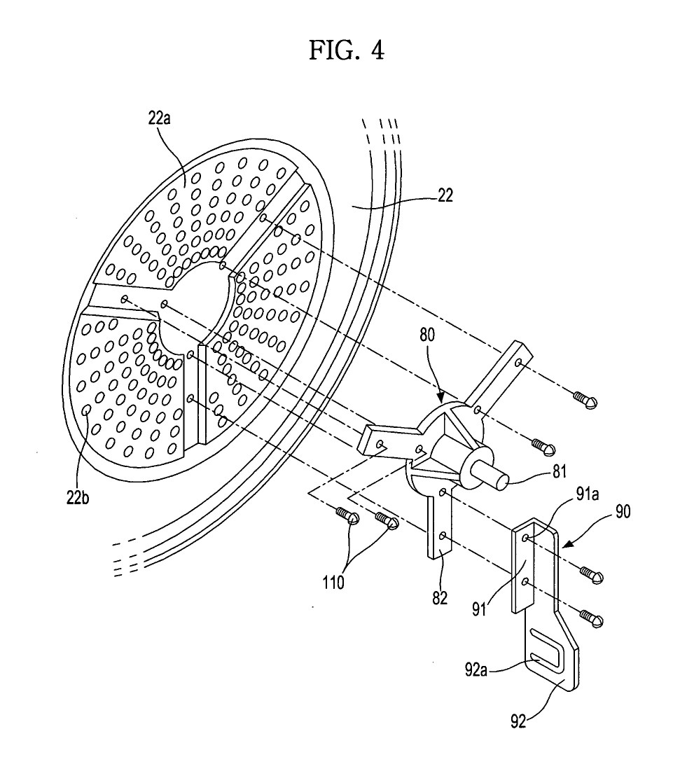

FIG. 2 is a longitudinal sectional view of a clothes drying machine in accordance with the present invention. FIG. 3 is a perspective view illustrating a rear panel of a housing and a rear plate of a drying tub of the clothes drying machine of the present invention. FIG. 4 is an exploded perspective view illustrating the connection among the rear plate of the drying tub, a flange, and a blade member of the clothes drying machine of the present invention.

As shown in FIGS. 2 and 3, the clothes drying machine of the present invention comprises a housing 10 forming an external appearance of the clothes drying machine, a drying tub 20 having a drum structure rotatably installed in the housing 10, a hot air entrance duct 30 for guiding heated air to the inside of the drying tub 20, a hot air exhaust duct 40 for exhausting the air in the drying tub 20, an air exhaust duct 50 extended to the outside of the housing 10, and an air exhaust fan 70 rotated by a motor 60 for forcibly exhausting the air in the drying tub 20.

The housing 10 has a hexahedral structure and forms the overall external appearance of the clothes drying machine. An opening 11 is formed through a front panel 17 of the housing 10 so that clothes are inserted into and taken out of the housing 10, and a door 12 for opening and closing the opening 11 is hinged to the front panel 17 of the housing 10 in front of the opening 11. A plurality of through holes 14 (FIG. 3) for causing external air to be inhaled to the inside of the housing 10 are formed through a designated region of a rear panel 13 of the housing 10. A heater 15 is installed in the upper portion of the rear panel 13 of the housing 10, and the hot air entrance duct 30 made of a metal is installed such that the heater 15 is surrounded with the hot air entrance duct 30. That is, the heater 15 is installed in a hot air entrance portion 31 of the hot air entrance duct 30 and a hot air exit portion 32 of the hot air entrance duct 30 is communicated with a rear plate 22 of the drying tub 20 so that air inhaled into the housing 10 via the through holes 14 is introduced to the opened hot air entrance portion 31, is heated by the heater 15, and is then exited to the rear plate 22 of the drying tub 20.

The drying tub 20 includes a front plate 21, the rear plate 22, and a side plate 23 having a cylindrical structure for connecting the front plate 21 and the rear plate 22. Here, the front plate 21, the rear plate 22, and the side plate 23 are made of metal. The drying tub 20 has a drum structure through a seaming process in which edge portions of the front plate 21 and the rear plate 22 and both ends of the side plate 23 are folded so that the front, rear and the side plates 21, 22, and 23 are connected. Particularly, an air entrance portion 22a is formed on the rear plate 22 of the drying tub 20 so that heated air introduced through the hot air entrance duct 30 is introduced to the inside of the drying tub 20, and a plurality of air entrance holes 22b are formed through the air entrance portion 22a.

The above drying tub 20 is rotated at a designated speed by the motor 60 installed below the housing 10. The motor 60 rotates the air exhaust fan 70 as well as the drying tub 20. For this reason, a rotary shaft 61 of the motor 60 is extended to both directions so that a pulley 62 is connected to one extended end of the rotary shaft 61 and the air exhaust fan 70 is connected to the other extended end of the rotary shaft 61. Here, a belt 63 is wound on the pulley 62 such that the outer cylindrical surface of the drying tub 20 is surrounded by the belt 63, thereby transmitting the rotary force of the pulley 62 to the drying tub 20.

The drying tub 20 is rotatably fixed to the inner surface of the rear panel 13 of the housing 10 by a flange 80. FIG. 4 is an exploded perspective view illustrating the connection among the rear plate of the drying tub 20, the flange 80, and a blade member 90 of the clothes drying machine of the present invention.

As shown in FIG. 4, the flange 80 provided with a support shaft 81 is connected to the rear surface of the rear plate 22 of the drying tub 20 by connectors 110 such that the drying tub 20 is supported by the inner surface of the rear panel 13 of the housing 10. The support shaft 81 is protruded from the central portion of the flange 80, and at least one support frame 82 is extended from the edge of the flange 80 in the radial direction of the rear plate 22 of the drying tub 20. FIG. 4 illustrates three support frames 82 separated from each other by a designated interval. The support frames 82 serve to firmly connect the flange 80 to the rear plate 22 of the drying tub 20, and to provide a region for supporting the blade member 90, which will be described later. Preferably, when the flange 80 is connected to the rear plate 22 of the drying tub 20, the center of the support shaft 81 coincides with the center of the drying tub 20 so that the rotation of the drying tub 20 is supported, thereby preventing the drying tub 20 from being unnecessarily vibrated.

The blade member 90 is fixed to the upper surface of one support frame 82 of the flange 80, i.e., the surface of one support frame 82 opposite to the surface of the support frame 82 contacting the rear plate 22 of the drying tub 20, so that the blade member 90 is rotated together with the rotation of the drying tub 20 to generate an air current. The blade member 90 includes a fixed portion 91 provided with connection holes 91a formed therethrough so that the blade member 90 is fixed to the flange 80 by the connectors 110, and a blade portion 92 vertically bent from the fixed portion 91 so that a vertically ascending air current is induced. Preferably, the area of the outer part of the blade portion 92 is larger than that of the inner part of the blade portion 92 so that the blade portion 92 efficiently generates the ascending air current.

An uneven portion 92a having a reverse “U” shape, as shown in FIG. 4, is formed on the blade portion 92, and serves to reinforce the blade portion 92 so that the blade portion 92 is not easily deformed by air resistance generated by the rotation of the blade portion 92 when the blade member 90 is made of a thin metal plate.

The above-described shape of the blade member 92 is exemplary, but is not limited thereto. That is, the blade member 92 may be variously formed so long as the blade member 92 is rotated together with the rotation of the drying tub 20 to induce an air current.

As shown in FIG. 3, an insertion hole 16, into which the support shaft 81 of the flange 80 is inserted so that the drying tub 20 is supported, is formed through the rear panel 13 of the housing 10. Accordingly, when the support shaft 81 of the flange 80, to which the blade member 90 is fixed, is inserted into the insertion hole 16, the drying tub 20 is rotatably supported by the housing 10. Here, the rear plate 22 of the drying tub 20 is located at a position communicated with the hot air exit portion 32 of the hot air entrance duct 30. Since the hot air entrance duct 30 is protruded from the inner surface of the rear panel 13 of the housing 10, a hot air entrance space 100 is formed between the outer surface of the rear plate 22 of the drying tub 20 and the inner surface of the rear panel 13 of the housing 10, and the flange 80 and the blade member 90 are located in the hot air entrance space 100.

Accordingly, when foreign substances, such as lint, are present in the lower portion of the hot air entrance space 100, the blade member 90 rotated together with the rotation of the drying tub 20 generates an air current to distribute the foreign substances and moves the foreign substances together with the hot air introduced to the inside of the drying tub 20, thereby preventing the foreign substances from accumulating in the lower portion of the hot air entrance space 100.

Further, as shown in FIG. 2, one or more lifters 24 are formed on the inner cylindrical surface of the side plate 23 of the drying tub 20 such that the lifters 24 are spaced from each other by a designated interval in the circumferential direction of the drying tub 20 and are arranged in parallel with the width direction of the drying tub 20. The lifters 24 move clothes, thereby causing the clothes to be efficiently dried.

The hot air exhaust duct 40 is installed in the lower portion of a space between the front panel 17 of the housing 10 and the front plate 21 of the drying tub 20, and serves to guide the air in the drying tub 20 so that the air is exhausted to the outside. One end 41 of the hot air exhaust duct 40 is communicated with the door 12 for receiving the air to be exhausted, and the air exhaust fan 70 driven by the motor 60 and the air exhaust duct 50 extended to the outside of the housing 10 are connected to the other end 42 of the hot air exhaust duct 40, through which hot air is exhausted to the outside. Thereby, when the air exhaust fan 70 is driven, the hot air containing moisture obtained by passing through the drying tub 20 is exhausted to the outside of the housing 10 through the hot air exhaust duct 40 and the air exhaust duct 50.

An exhaust hole 12a for exhausting air in the drying tub 20 therethrough is formed through the surface of the door 12 contacting the opening 11, and a filter 43 for collecting the foreign substances, such as lint, contained in the exhausted hot air is installed in the exhaust hole 12a.

Hereinafter, with reference to FIGS. 2 and 3, the above operation of the clothes drying machine of the present invention will be described.

When wet clothes are inserted into the drying tub 20 and the clothes drying machine is operated in a drying mode, power is applied to the heater 15 and the motor 60 and the operation of the clothes drying machine is started. When the motor 60 is driven, the air exhaust fan 70 forcibly exhausts the air present in the drying tub 20 to the outside through the hot air exhaust duct 40 and the air exhaust duct 50. Thereby, the pressure in the drying tub 20 is greatly lowered so that the air in the housing 10 passes through the hot air entrance duct 30, is heated by the heater 15, and is introduced into the drying tub 20 through the air entrance holes 22b formed through the rear plate 22 of the drying tub 20. Here, external air is introduced into the housing 10 through the through holes 14 formed through the rear panel 13 of the housing 10.

That is, when the motor 60 and the heater 15 are operated, external air passes through the through holes 14, the inside of the housing 10, the hot air entrance portion 31 of the hot air entrance duct 30, and the heater 15 so that the air is heated by the heater 15, is introduced into the drying tub 20 through the hot air exit portion 32 of the hot air entrance duct 30 and the air entrance holes 22b so that the air evaporates moisture of clothes present in the drying tub 20, and is exhausted to the outside of the housing 20 through the air exhaust hole 12a, the hot air exhaust duct 40, and the air exhaust duct 50.

The driving force of the motor 60 is transmitted to the drying tub 20 through the belt 63 so that the drying tub 20 is rotated. Thereby, the clothes present in the drying tub 20 are lifted and then dropped by the lifters 24, thus being uniformly dried without wrinkles.

Generally, various kinds of dust are present in air. When dust passes through the air entrance holes 22b formed through the rear plate 22 of the drying tub 20, the dust accumulates in the lower portion of the hot air entrance space 100 formed between the rear plate 22 of the drying dub 20 and the hot air exit portion 32 of the hot air entrance duct 30. Foreign substances, such as lint generated when the clothes in the drying tub 20 are dried, are discharged to the hot air entrance space 100 through the air entrance holes 22b, thus accumulating also in the lower portion of the hot air entrance space 100. The clothes drying machine of the present invention comprises the blade member 90 installed outside the rear plate 22 of the drying tub 20. The blade member 90 is rotated together with the rotation of the drying tub 20, and generates an air current, thereby dispersing the dust or foreign substances and moving the dust or foreign substances to the inside of the drying tub 20 together with the movement of the hot air. Therefore, the blade member 90 prevents the dust or foreign substances from accumulating in the lower portion of the hot air entrance space 100. The foreign substances introduced into the drying tub 20 together with the hot air pass through again the exhaust hole 12a, and are collected by the filter 43.

As apparent from the above description, the present invention provides a clothes drying machine, which prevents foreign substances, such as lint, from accumulating in the lower portion of a hot air entrance space formed between a hot air entrance duct and an air entrance portion of a rear plate of a drying tub, and a method for removing foreign substances therefrom, thereby preventing the danger of firing the foreign substances, thus improving the stability of the machine.

Further, the clothes drying machine and the method for removing foreign substances therefrom of the present invention eliminate the foreign substances hindering the smooth flow of hot air, thereby preventing the deterioration of the drying efficiency of the machine.

Although exemplary embodiments of the invention have been shown and described, it would be appreciated by those skilled in the art that changes may be made in these embodiments without departing from the principles and spirit of the invention, the scope of which is defined in the claims and their equivalents.

What is claimed is:

1. A clothes drying machine comprising:
a drying tub rotatably installed in a housing; and
a blade member installed outside a rear plate of the drying tub and rotated together with the rotation of the drying tub for generating an air current to eliminate foreign substances from accumulating in a space formed outside the rear plate of the drying tub.

2. A clothes drying machine comprising:
a drying tub rotatably installed in a housing;
a hot air entrance duct that communicates with a rear plate of the drying tub for introducing hot air to the inside of the drying tub; and
a blade member fixed to the rear plate of the drying tub for preventing foreign substances from accumulating in a hot air entrance space formed between the rear plate of the drying tub and a hot air exit portion of the hot air entrance duct.

3. The clothes drying machine as set forth in claim 1, wherein a flange provided with an integrally formed support shaft is connected to the rear plate of the drying tub so that the drying tub is rotatably supported by a rear panel of the housing, and the blade member is fixed to the flange.

4. The clothes drying machine as set forth in claim 3, wherein the blade member includes:
a fixed portion fixed to the flange; and
a blade portion vertically bent from the fixed portion.

5. The clothes drying machine as set forth in claim 4, wherein the support shaft is protruded from the central portion of the flange, and at least one support frame is extended from the central portion of the flange in the radial direction of the rear plate of the drying tub so that the fixed portion of the blade member is connected to the upper portion of the support frame.

6. The clothes drying machine as set forth in claim 4, wherein the outer part of the blade portion has an expanded area so that the blade portion efficiently generates an ascending air current to eliminate foreign substances.

7. The clothes drying machine as set forth in claim 4, wherein an uneven portion for reinforcing the blade portion is formed on the blade portion so that the blade portion is not deformed by air resistance generated when the blade portion is rotated.

8. The clothes drying machine as set forth in claim 1, wherein a door for opening and closing the drying tub is provided on a front panel of the housing, and a filter for collecting foreign substances is installed on the rear surface of the door.

9. The clothes drying machine as set forth in claim 1, wherein the blade member generates a vertically flowing air current for dispersing foreign substances present in the space formed outside the rear plate of the drying tub.

10. A method for removing foreign substances from a clothes drying machine comprising:
dispersing foreign substances present in a space formed between an air entrance portion of a rear plate of a drying tub and a housing by an air current generated by a blade member fixed to the rear plate of the drying tub rotatably installed in the housing and rotating together with the rotation of the drying tub;
introducing the dispersed foreign substances together with air introducing from a hot air entrance duct that communicates with the rear plate of the drying tub into the drying tub; and
collecting the foreign substances introduced into the drying tub through a filter installed in a door installed on a front panel of the housing.

11. The clothes drying machine as set forth in claim 2, wherein a flange provided with an integrally formed support shaft is connected to the rear plate of the drying tub so that the drying tub is rotatably supported by a rear panel of the housing, and the blade member is fixed to the flange.

12. The clothes drying machine as set forth in claim 11, wherein the blade member includes:
a fixed portion fixed to the flange; and
a blade portion vertically bent from the fixed portion.

13. The clothes drying machine as set forth in claim 12, wherein the support shaft is protruded from the central portion of the flange, and at least one support frame is extended from the central portion of the flange in the radial direction of the rear plate of the drying tub so that the fixed portion of the blade member is connected to the upper portion of the support frame.

14. The clothes drying machine as set forth in claim 12, wherein the outer part of the blade portion has an expanded area so that the blade portion efficiently generates an ascending air current to eliminate foreign substances.

15. The clothes drying machine as set forth in claim 12, wherein an uneven portion for reinforcing the blade portion is formed on the blade portion so that the blade portion is not deformed by air resistance generated when the blade portion is rotated.

16. The clothes drying machine as set forth in claim 2, wherein a door for opening and closing the drying tub is provided on a front panel of the housing, and a filter for collecting foreign substances is installed on the rear surface of the door.
